(19) United States
(12) Patent Application Publication
(10) Pub. No.: US 2010/0114632 A1
(43) Pub. Date: May 6, 2010

(54) Pattern-based process optimizer

(75) Inventors: Amit Agrahari, Chattisgarh (IN); Shivi Mithal, Uttar Pradesh (IN); Jyoti M. Bhat, Bangalore (IN)

Correspondence Address: LERNER, DAVID, LITTENBERG,;KRUMHOLZ & MENTLIK, 600 SOUTH AVENUE WEST, WESTFIELD, NJ, 07090, US

(73) Assignee: Infosys Technologies Limited, Bangalore (IN)

(21) Appl. No.: 12/317,932

(22) Filed: Dec. 30, 2008

(30) Foreign Application Priority Data
Nov. 3, 2008 (IN) 2668/CHE/2008

(51) Int. Cl. G06Q 10/00

(52) U.S. Cl. 705/7

(57) ABSTRACT

The present invention provides a method, system and computer program product for optimizing business processes in an organization. Each business process to be optimized is characterized by one or more performance indicators. One or more process characteristics are identified corresponding to each of the performance indicators. For each of the process characteristics, at least one transformation pattern is identified. Thereafter, one or more transformation patterns are selected from the identified transformation patterns, for optimizing the process characteristics, and thereby optimizing the business processes.

### BACKGROUND OF THE INVENTION

The present invention relates to optimizing business processes in an organization.

An organization employs a variety of processes at different stages of its operations. The organization is constantly looking for ways to improve its operations. There are multiple ways to enhance the functions of the organization such as by improving the efficiency of existing business processes, by redesigning existing business processes, or by introducing new business processes.

Typically, any innovation in a business process is preceded by a thorough study of the process characteristics associated with the process. A process characteristic refers to the property of a business process that is affected or altered by the outcome of the business process redesign. Examples of process characteristics include cost, time, quality, and the like. Improvements in the business processes are aimed at altering the process characteristics to result in a desired output. For example, process improvements may be aimed at reducing associated cost and processing time. Generally, process improvements are implemented to address issue(s), problems(s), or improvement opportunities associated with the process.

Conventionally, improvements in processes are suggested by consultants with the help of various tools. However, the tools currently used only have data capturing and simulation capabilities, and they do not provide recommendations regarding the alterations that should be made in the process. Further, simulation can only help for a limited set of process characteristics, such as time and cost, and cannot help in improving other process characteristics that may impact a process' efficiency, such as flexibility, reliability, and so forth.

In light of the above, there is a need for a method, system and computer program product for efficiently optimizing business processes in the organization based on the available information.

### BRIEF SUMMARY OF THE INVENTION

An object of the invention is to optimize business processes in an organization.

To achieve the objective mentioned above, the present invention provides a method, system and computer program product for optimizing business processes in an organization. An organization uses multiple business processes for its various groups and functions. In accordance with the embodiments provided in the invention, the various business processes are optimized or redesigned to improve the functions of the organization and/or to resolve issues, problems, or improvement opportunities associated with the business processes. In accordance with an embodiment of the invention, a business process to be optimized is selected. Further, at least one of the performance indicators and the improvement opportunities corresponding to the business process is identified. Thereafter, one or more process characteristics corresponding to each of the identified performance indicators and/or improvement opportunities are identified. Further, at least one transformation pattern corresponding to the identified process characteristics is identified. The transformation patterns are identified from a predefined set of transformation patterns on the basis of a predefined criterion. Furthermore, one or more transformation patterns are selected from the identified transformation patterns on the basis of the applicability of the identified transformation patterns in the business process. The selected transformation patterns are applied to optimize the identified process characteristics and thereby optimize the business process.

Various embodiments of the invention have several advantages. The method provides a practitioner or a consultant with an efficient method for optimizing and redesigning business processes. Further, the business processes can be redesigned by using the available information since the method does not impose any rigid information requirement. Furthermore, the present invention provides a method for process redesign that is easy to understand and simple to implement. Moreover, the present invention brings structure into the art of process redesign.

### BRIEF DESCRIPTION OF THE DRAWINGS

The various embodiments of the invention will hereinafter be described in conjunction with the appended drawings, provided to illustrate and not to limit the invention, wherein like designations denote like elements, and in which:

FIG. 1 is a flowchart of a method for optimizing business processes in an organization, in accordance with an embodiment of the invention;

FIG. 2 is a flowchart of a method for identifying transformation patterns corresponding to process characteristics, in accordance with an embodiment of the invention;

FIG. 3a and FIG. 3b are a flowchart of a method for selecting transformation patterns for optimizing the process characteristics, in accordance with an embodiment of the invention; and

FIG. 4 is a block diagram of a system for optimizing the business processes in the organization, in accordance with an embodiment of the invention.

### DETAILED DESCRIPTION

The invention describes a method, system and computer program product for optimizing business processes in an organization. The performance of each business process to be optimized is measured by one or more performance indicators, each of which corresponds to one or more process characteristics. One or more transformation patterns are selected to optimize the process characteristics and thereby optimize the business processes.

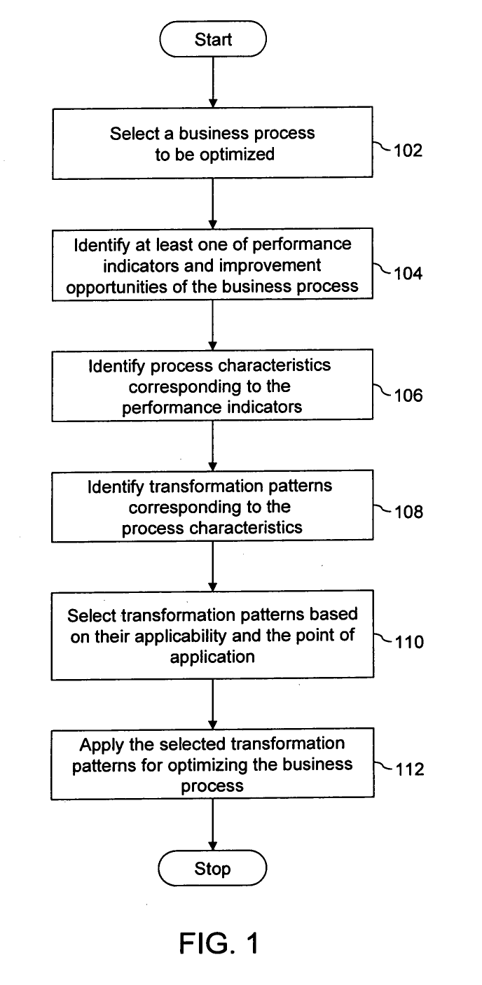

FIG. 1 is a flowchart of a method for optimizing business processes in an organization, in accordance with an embodiment of the invention.

Typically, an organization employs various business processes, hereinafter interchangeably referred to as processes, in various departments and at various stages of its function. These processes need to be optimized or redesigned in order to improve the functions of the organization and/or to resolve the issues in the business processes.

At step 102, a business process to be optimized is selected. The business process is selected from the various business processes in the organization that need to be optimized or redesigned. For example, an organization, such as a bank, employs different processes such as savings account opening process, cheque clearance process, and so forth. In an exemplary scenario, when both the processes mentioned above need to be optimized, then each process is selected separately.

At step 104, at least one of one or more performance indicators and one or more improvement opportunities is identified. The performance indicators and the improvement opportunities correspond to the business process, and therefore, either of the two or both are identified corresponding to the business process. Performance indicators, also referred to as process performance indicators or key performance indicators, refer to the parameters or metrics that are used to define or measure the performance of a business process. For example, the performance indicators for the savings account opening process can be related to the number of calls received by a call center per account opened, the number of lost mails corresponding to opening of account, and so forth. In an embodiment of the invention, the performance indicators are identified by a business user or the people who own or run the business, based on the business requirements of the organization. For example, if a computer manufacturing organization needs to increase its profitability by improving its customizability, then the performance indicators for the organization will include collecting customer requirements properly. On the other hand, if the organization needs to capture the market by introducing low-cost products, then ‘cost’ will be the performance indicator for the organization. The performance indicators are identified using a reference list containing predefined performance indicators. In another embodiment of the invention, the performance indicators for a process are defined by a business user, based on the business requirements of the organization. In other words, rather than identifying or selecting the performance indicators from the reference list, a business user defines the performance indicators.

In an embodiment of the present invention, in addition to or in place of performance indicators, one or more improvement opportunities are identified. The improvement opportunities, also referred to as problem statements, are associated with the business process and refer to the issues or problems associated with the business process that need to be resolved by the organization. For example, in a bank, the following can be the different improvement opportunities, also referred to as issues, associated with the savings account opening process:
1. After submitting account opening forms, customers receive documents related to the bank account after some delay. However, they expect the account to be operational in a short period of time.
2. Significant number of calls received by the bank's call centers because of the delay in the delivery of one or more documents related to the bank account.
3. Cost of resending delayed or lost documents.
4. Customers are dissatisfied due to non-receipt of the documents related to the bank account.
5. Significant cost of stationery.

In an embodiment of the invention, the improvement opportunities are identified by a user. It will be apparent to a person skilled in the art that the improvement opportunities are identified by a business user on the basis of the business requirements of the organization.

At step 106, one or more process characteristics are identified. A process characteristic, also referred to as an improvement characteristic, refers to the property of the business process that is affected or altered by the outcome of the business process redesign. In other words, process characteristics are the fundamental attributes of the process. Examples of process characteristics include cost, time, quality, and the like. The process characteristics are identified from a predefined set of process characteristics. The predefined set of process characteristics includes, but is not limited to, process characteristics such as cost, time, flexibility, reliability, throughput, effectiveness, quality, and control. In an embodiment of the invention, the predefined set of process characteristics is stored in a pattern repository. Each process characteristic corresponds to one or more performance indicators of the business process and vice versa. In an exemplary scenario, the relationship between process characteristics and performance indicators can be defined in the following way: process characteristic X increases with performance indicator P and decreases with performance indicator Q; process characteristic Y decreases with both performance indicator Q and performance indicator R; and so forth.

In an embodiment of the invention, the performance indicators are associated with at least one of the process characteristics included in the predefined set of process characteristics. The association between the performance indicators and the process characteristics is predefined. However, the predefined associations between the process characteristics and the performance indicators can be modified or altered by a consultant or a practitioner on the basis of the improvements or changes required in the business process. In another embodiment of the invention, the association between the user-defined performance indicators and the process characteristics is defined by a user. It will be apparent to a person skilled in the art that the association between the performance indicators and the process characteristics is defined by a consultant or a practitioner.

In an embodiment of the invention, the impact of the process characteristics on the performance indicators is identified. The association between the performance indicators and the process characteristics helps in determining the impact of the process characteristics on the performance indicators. For example, in the savings account opening process in a bank, the performance indicator identified is the number of calls made to a call center per account. Further, if it is ascertained that the majority of the calls are because of the delay in the delivery of documents related to bank account, then the process characteristic ‘time’ needs to be decreased. On the contrary, if it is ascertained that customer requests are not being addressed and the customers are calling repeatedly, then the process characteristic ‘reliability’0 needs to be increased.

At step 106, the improvement opportunities are associated with the process characteristics. For example, of the five improvement opportunities or issues identified for the savings account opening process, the issue of delay in receiving documents by a customer, relates to the process characteristic ‘cycle time’. The issues, for example, the number of calls made to call centers, the cost of resending documents to the customers, and dissatisfaction of the customers due to non-receipt of the documents, are the result of an unreliable process, which fails or breaks down during execution, that is, these issues relate to reliability whereas the issue of cost of stationery relates to cost. In an embodiment of the invention, the association between the improvement opportunities and the process characteristics is defined by a user. It will be apparent to a person skilled in the art that the association between the improvement opportunities and the process characteristics is defined by a consultant or a practitioner on the basis of the improvements or changes required in the business process.

In an embodiment of the invention, the association of the performance indicators and/or the improvement opportunities with the process characteristics is defined by using process maps as inputs. A process map describes a business process in terms of the activities involved in the business process and the people involved in performing the activities. In an embodiment of the invention, the process maps are diagrammatically represented in the form of flowcharts.

In an embodiment of the invention, at step 106, some of the process characteristics are also identified as constraints. Based on the significance of the process characteristics in achieving the business goal of the organization, some process characteristics are characterized as constraints. Constraints are the restrictions on the business process and refer to the process characteristics that should not change. In other words, a process characteristic is identified as a constraint if it remains unaffected in the optimized or redesigned business process. For example, the issue of significant cost of stationery related to the savings account opening process, stated in reference to step 104, is a relatively less significant issue for the bank as compared to the other issues; therefore, the corresponding process characteristic ‘cost’ is identified as a constraint. In other words, although the optimized business process may not reduce the process characteristic corresponding to this issue, the optimized business process should also not increase the process characteristic ‘cost’. In an embodiment of the invention, the identification of the process characteristics as constraints is performed by a business user.

At step 108, at least one transformation pattern corresponding to the process characteristics is identified. Transformation patterns are abstractions of the changes that can be performed in a process. Examples of transformation patterns include re-sequencing, task elimination, centralization, and the like. The transformation pattern is identified from a predefined set of transformation patterns. In an embodiment of the present invention, the predefined set of transformation patterns includes, but is not limited to, transformation patterns, such as, ‘Control Relocation’, ‘Contact Reduction’, ‘Integration’, ‘Task Elimination’, ‘Triage’, ‘Task Composition’, ‘Re-sequencing’, ‘Exception’, ‘Split Responsibilities’, ‘Extra Resources’, ‘Buffering’, ‘Task Automation’, ‘Outsourcing’, and ‘Interfacing’. Each transformation pattern in the predefined set of transformation patterns corresponds to at least one of the process characteristics and vice versa. In an embodiment of the invention, the predefined set of transformation patterns is stored in a pattern repository. The transformation patterns have been described in detail in conjunction with Reijers et al., “Best practices in business process redesign: an overview and qualitative evaluation of successful redesign heuristics” Omega 33 (2005) pp. 283-306, the contents of which have been incorporated herein by reference.

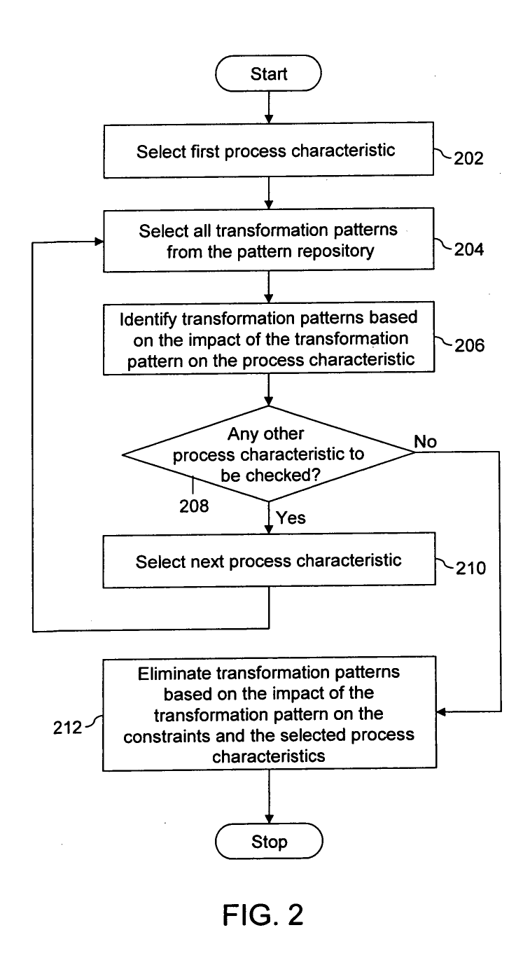

The transformation patterns are identified on the basis of at least one predefined criterion. The predefined criterion includes, but is not limited to, a predefined relation between the transformation pattern and the process characteristic. In an embodiment of the invention, the predefined relation between the transformation pattern and the process characteristic includes the impact of the transformation pattern on the process characteristic. The impact refers to the effect of applying a transformation pattern on the process characteristics. A transformation pattern can have a positive, negative or neutral impact on a process characteristic. For example, let us consider that process characteristic X needs to be increased. If process characteristic X increases when transformation pattern P is applied, then transformation pattern P has a positive impact on process characteristic X. On the contrary, if process characteristic X decreases, this implies that transformation pattern P has a negative impact on process characteristic X. The predefined relation also includes the impact of the transformation pattern on the process characteristics identified as constraints. For example, in the savings account opening process having cycle time and reliability as process characteristics, and cost as a constraint, the transformation patterns identified from the predefined set of transformation patterns include ‘Control Relocation’, ‘Contact Reduction’, ‘Integration’, ‘Task Elimination’, ‘Order-based Work’, ‘Triage’, ‘Task Composition’, ‘Re-sequencing’, ‘Exception’, ‘Order Assignment’, ‘Flexible Assignment’, ‘Centralization’, ‘Case Manager’, ‘Extra Resources’, ‘Specialist-Generalist’, ‘Buffering’, ‘Task Automation’, ‘Integral Business Process Technology’, ‘Trusted Party’, and ‘Interfacing’. The transformation patterns identified above have a positive impact on at least one of the two process characteristics, cycle time and reliability, that is, each of the transformation patterns either reduces the cycle time and/or improves the reliability of the process. The identification of the transformation patterns corresponding to the process characteristics has been explained in detail in conjunction with FIG. 2.

In an embodiment of the invention, the predefined criterion for identifying the transformation patterns is stored in a pattern repository. In other words, the impact of the transformation pattern on the process characteristic is stored in the pattern repository. In an embodiment of the invention, the impact of the transformation pattern on the process characteristic is stored in the following format:

TABLE 1
Relation between a transformation pattern
and its impact on process characteristics

| | | Positive | Negative |
|---|---|---|---|
| Pattern Name | Description | Impact | Impact |
| Split | Shared responsibility | Time | |
| Responsibilities | between two departments | Quality | |
| | is often a cause of | | |
| | neglect, conflict and | | |
| | hence delays. This best | | |
| | practice identifies this | | |
| | fact and suggests to | | |
| | reduce overlap in | | |
| | responsibilities to avoid | | |
| | these problems. | | |

Table 1: Relation between a transformation pattern As shown above, Table 1 includes the name of the transformation pattern, its description, the process characteristic(s) on which it has a positive impact and the process characteristic(s) on which it has a negative impact. If a process characteristic is not mentioned with a transformation pattern, it means that the transformation pattern has a neutral impact on that process characteristic.

At step 110, one or more transformation patterns are selected. The transformation patterns are selected from the transformation patterns identified at step 108. The transformation patterns are selected on the basis of the applicability of the identified transformation patterns. In other words, the identified transformation patterns are subjected to a test of applicability in order to select transformation patterns from the transformation patterns identified at step 108. For example, in the savings account opening process, based on the applicability of the 20 identified transformation patterns stated in reference to step 108, 11 transformation patterns that are selected from the 20 identified transformation patterns include ‘Contact Reduction’, ‘Order-based Work’, ‘Triage’, ‘Re-sequencing’, ‘Order Assignment’, ‘Centralization’, ‘Buffering’, ‘Task Automation’, ‘Integral Business Process Technology’, ‘Trusted Party’, and ‘Interfacing’. Since every transformation pattern is not applicable to every business situation, transformation patterns are selected or shortlisted on the basis of their applicability in the business process.

The applicability of the identified transformation patterns is checked by using a set of data points corresponding to the business process. Data points refer to the information corresponding to the business process that is used to check the applicability of the transformation patterns. For example, data points such as, mean time to execute the process, standard deviation of the time to execute the process, the number of cases where standard deviation is ‘High’, and the like, are used to check the applicability of the transformation pattern ‘Exception’. In an embodiment of the invention, the data points corresponding to the business process are analyzed. The data points are then used to check the applicability of the identified transformation patterns and to select one or more transformation patterns from the identified transformation patterns. For example, in the savings account opening process, based on the analysis of the data points such as set-up time, processing time, and so forth, the 11 transformation patterns listed above are selected from the 20 identified transformation patterns stated in reference to step 108. The transformation pattern ‘Extra Resources’ is rejected since the processing time of the business steps is less, as compared to the overall process time. Furthermore, the transformation pattern ‘Task Composition’ is rejected since the set-up time required for each step is less, as compared to the overall process time. Similarly, based on the analysis of the other data points, only 11 transformation patterns are selected from the 20 identified transformation patterns stated in reference to step 108 and other transformation patterns are rejected. In an embodiment of the invention, the data points are stored in the pattern repository.

In an embodiment of the invention, analyzing the set of data points includes applying one or more applicability algorithms to check the applicability of the identified transformation patterns. The applicability algorithms include one or more mathematical formulae that utilize the data points to check the applicability of the identified transformation patterns. For example, the following applicability algorithm is used to check the applicability of the transformation pattern ‘Exception’:

If Standard Deviation=‘High’ AND Number of cases where standard deviation is ‘High’>30% THEN Apply pattern ‘Exception’

Table 1: Relation between a transformation pattern In an embodiment of the invention, the applicability algorithms are stored in the pattern repository.

The transformation patterns are selected from the identified transformation patterns to optimize the process characteristics. The transformation patterns that satisfy the constraints are also selected. For example, in the savings account opening process, the 11 transformation patterns stated in reference to step 110, which are selected from the 20 identified transformation patterns stated in reference to step 108, are used to optimize the process characteristics. The optimization of the process characteristics resolves the issues or the improvement opportunities, improves the performance indicator and satisfies the constraints. The optimization of the process characteristics, thereby optimizes the corresponding business process.

At step 110, one or more points of applicability of the selected transformation patterns are identified. The selected transformation patterns are applied in the business process at the one or more points of applicability. For example, in the savings account opening process, the transformation pattern ‘Triage’ is applied at the point of delivery of documents related to opening of bank account.

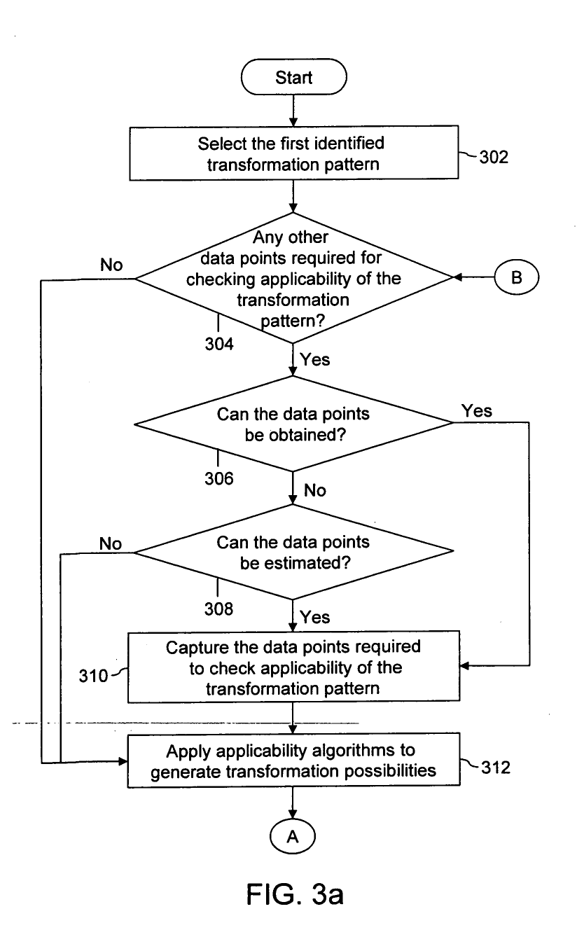

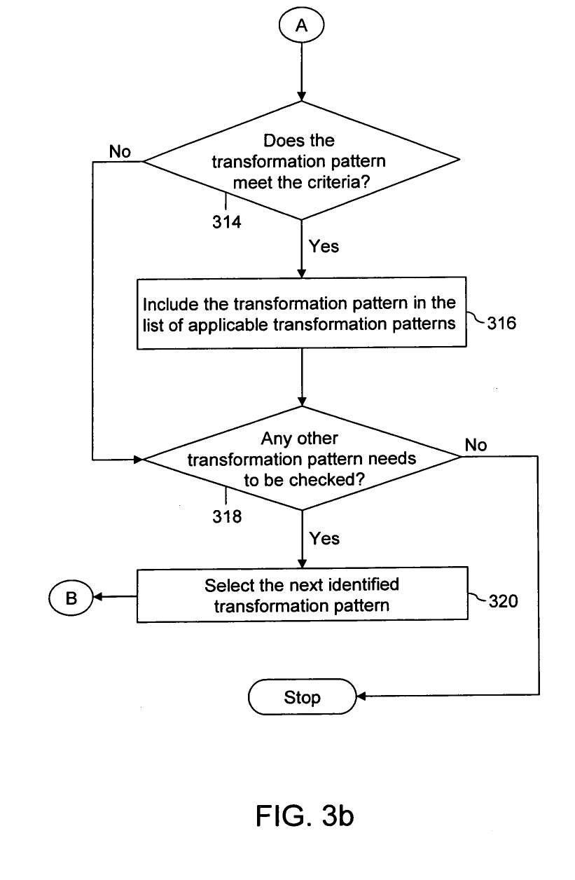

The selection of the transformation patterns to optimize the process characteristics has been explained in detail in conjunction with FIG. 3a and FIG. 3b.

At step 112, the transformation patterns selected at step 110 are applied to optimize the business process. The selected transformation patterns are analyzed by a consultant or a practitioner to check their applicability. The consultant or practitioner along with the business user(s) verifies the applicability of the selected transformation patterns depending on the business situation. Based on the practical applicability, the selected transformation patterns are applied in the business process at their respective points of applicability. The applicability of the transformation patterns in the business process provides a resolution for the issues or improvement opportunities associated with the business process, and therefore, optimize the business process.

For example, in the savings account opening process, the following 7 transformation patterns are selected from the 11 selected transformation patterns stated in reference to step 110: ‘Order-based Work’, ‘Triage’, ‘Re-sequencing’, ‘Centralization’, ‘Task Automation’, ‘Contact Reduction’, and ‘Integral Business Process Technology’. These 7 transformation patterns are selected on the basis of their practical applicability and are used by the bank to optimize the process characteristics, such as cycle time and reliability, thereby optimizing the business process.

In an embodiment of the invention, the resolution obtained by applying the transformation patterns is stored in a pattern repository. In an embodiment of the invention, the resolution obtained is stored in the following format along with the corresponding transformation pattern's name and the data points, that is, the information required to check the applicability of the transformation pattern:

TABLE 2
Suggested resolution for a transformation
pattern

| Pattern Name | Information | Resolution |
|---|---|---|
| Split | Information Need | The resolution is to |
| Responsibilities | 1. No. of departments in | involve the person |
| | process | having the functional |
| | 2. No. of reconciliation | knowledge in the team |
| | activities | where the transaction |
| | 3. No. of co-ordination | data is generated. |
| | activities | Example, a HR or a |
| | 4. Mean time taken to | Finance person can |
| | complete the process | join the production |
| | and its standard | team, or a product |
| | deviation | development person can |
| | | join the CRM team. |

Table 1: Relation between a transformation pattern In an embodiment of the invention, the result of the application of the selected transformation patterns is checked by using simulations. The result is checked by comparing the outcomes of the optimized business process and the original business process in terms of the performance indicators, the improvement opportunities and the impact of the improvement opportunities on the process characteristics, that is, in terms of resolution of the issues or improvement characteristics. For example, in the savings account opening process, by applying the selected transformation patterns, such as ‘Re-sequencing’, ‘Contact Reduction’, and the like, the cycle time was reduced from a period of 2 to 3 weeks to a period of three days, which was within the customers' expectations, and the number of calls received by the call center also reduced significantly.

In an exemplary scenario describing the applicability of the present invention, an organization, such as a bank, employs different business processes, such as savings account opening, cheque clearance, and the like. The business process such as savings account opening process needs to be optimized and is therefore selected. Thereafter, the improvement opportunities or issues associated with the process are identified. Examples of the improvement opportunities or issues associated with the savings account opening process include delay in delivery of documents related to bank account, the number or volume of calls received by the bank's call center due to the delay, the cost of resending the lost documents, customer dissatisfaction due to non-receipt of documents, the cost of stationery, and the like. Process characteristics such as cost, cycle time and reliability, are identified for the corresponding improvement opportunities. The issue of delay in delivery of documents related to the bank account relates to the process characteristic ‘cycle time’; and the issue of cost of stationery relates to the process characteristic ‘cost’. Similarly, issues that are related to the process characteristic ‘reliability’ include the number of calls made to the bank's call center due to the delay in delivery of account-related documents to the customers, the cost of resending the lost documents, and customer dissatisfaction due to non-receipt of the documents. Since the issue related to the cost of stationery is relatively less significant for the bank as compared to the other issues, the process characteristic ‘cost’ is identified as a constraint.

The following 20 transformation patterns corresponding to cycle time and reliability as process characteristics and cost as a constraint are then identified: ‘Control Relocation’, ‘Contact Reduction’, ‘Integration’, ‘Task Elimination’, ‘Order-based Work’, ‘Triage’, ‘Task Composition’, ‘Re-sequencing’, ‘Exception’, ‘Order Assignment’, ‘Flexible Assignment’, ‘Centralization’, ‘Case Manager’, ‘Extra Resources’, ‘Specialist-Generalist’, ‘Buffering’, ‘Task Automation’, ‘Integral Business Process Technology’, ‘Trusted Party’, and ‘Interfacing’. These transformation patterns are identified from the predefined set of transformation patterns that have a positive impact on the process characteristics. Based on the list of the 20 transformation patterns, some data points required to check the applicability of the 20 identified transformation patterns are identified. Thereafter, transformation patterns are selected from the identified transformation patterns on the basis of their applicability, and non-applicable transformation patterns are eliminated. Data points such as queue time, set-up time and process time, bank liability in case of fraud, and so forth, assist in eliminating the non-applicable transformation patterns. Based on the analysis of the data points, i.e., by applying the applicability algorithms, few transformation patterns are eliminated from the 20 identified transformation patterns. For example, the transformation pattern ‘Task Composition’ is eliminated since the set-up time is less, as compared to the total process time. Further, the transformation pattern ‘Control Relocation’ is eliminated since it increases the possibility of fraud. The following is the list of the selected transformation patterns to be applied in the business process: ‘Contact Reduction’, ‘Order-based Work’, ‘Triage’, ‘Re-sequencing’, ‘Order Assignment’, ‘Centralization’, ‘Buffering’, ‘Task Automation’, ‘Integral Business Process Technology’, ‘Trusted Party’, and ‘Interfacing’. These selected transformation patterns are then analyzed by a consultant along with the business user(s) to verify the practical applicability of the selected transformation patterns, based on which the following 7 transformation patterns are finally selected: ‘Order-based Work’, ‘Triage’, ‘Re-sequencing’, ‘Centralization’, ‘Task Automation’, ‘Contact Reduction’, and ‘Integral Business Process Technology’. Based on the list of the selected transformation patterns, the practitioner or consultant applies these transformation patterns to optimize or redesign the business process.

FIG. 2 is a flowchart of a method for identifying transformation patterns corresponding to process characteristics, in accordance with an embodiment of the invention.

Each process characteristic has at least one corresponding transformation pattern which is identified at step 108, as explained in conjunction with FIG. 1. The transformation patterns are identified from the predefined set of transformation patterns. In an embodiment of the invention, the predefined set of transformation patterns is stored in a pattern repository.

The identification of the transformation patterns requires the predefined set of transformation patterns as an input. At step 202, a first process characteristic is selected. The first process characteristic is selected from the process characteristics identified at step 106, as explained in conjunction with FIG. 1. Thereafter, all the identified process characteristics are selected individually. Further, at step 204, all the transformation patterns stored in the pattern repository are selected. In other words, all the transformation patterns in the predefined set of transformation patterns are selected.

At step 206, one or more transformation patterns are identified from the transformation patterns selected at step 204. The transformation patterns are identified on the basis of the impact of the transformation patterns on the selected process characteristic. For example, let us consider that process characteristic X needs to be increased. If process characteristic X increases when transformation pattern P is applied, then transformation pattern P has a positive impact on process characteristic X. On the contrary, if process characteristic X decreases, this implies that transformation pattern P has a negative impact on process characteristic X. In an embodiment of the invention, the transformation patterns having a positive impact on the process characteristics are identified. All the transformation patterns having a positive impact on the selected process characteristics are identified from the predefined set of transformation patterns. For example, for process characteristic X, 15 transformation patterns are identified from the transformation patterns included in the predefined set of transformation patterns. The 15 transformation patterns thus identified have a positive impact on process characteristic X. In an embodiment of the invention, the impact of the transformation patterns on the process characteristics is stored in the pattern repository, as explained in conjunction with FIG. 1.

At step 208, it is determined whether any other process characteristic needs to be selected or checked. All the process characteristics identified at step 106 are checked separately at step 208. If more than one process characteristic identified at step 106 needs to be selected, the process moves to step 210. If all the identified process characteristics have been selected or checked, the process moves to step 212. At step 210, the next process characteristic is selected. The next process characteristic is selected from the process characteristics identified at step 106. Thereafter, the process moves to step 204 to select all the transformation patterns from the predefined set of transformation patterns. Thereafter, at step 206, the transformation patterns corresponding to the selected process characteristic are identified. The transformation patterns are identified from the predefined set of transformation patterns on the basis of the impact of the transformation patterns on the selected process characteristic as explained above. Further, the transformation patterns having a positive impact on the process characteristics selected at steps 202 and 210 are selected from the identified transformation patterns. For example, for process characteristic Y, 10 transformation patterns are identified from the predefined set of transformation patterns. Suppose 8 transformation patterns are common between the transformation patterns identified for process characteristic X as well as Y i.e. these 8 transformation patterns have a positive impact on both, process characteristic X and process characteristic Y. Therefore, the remaining 2 transformation patterns (10−8) are added to the original list of 15 identified transformation patterns and therefore, the number of the identified transformation patterns increases to 17. Similarly, steps 208 and 210 are repeated until no other process characteristic needs to be selected.

If all the identified process characteristics have been selected or checked, the process moves to step 212 to eliminate the transformation patterns on the basis of their impact on the constraints and the process characteristics selected at steps 202 and 210. At step 212, the transformation patterns having a negative impact on the process characteristics identified as constraints and other process characteristics selected at steps 202 and 210 are eliminated. The eliminated transformation patterns are selected from the transformation patterns identified at step 206. For example, when process characteristic Z is identified as a constraint, and if 2 of the 17 transformation patterns identified above have a negative impact on process characteristic Z, then the 2 transformation patterns are eliminated from the 17 identified transformation patterns. Also, if any of the 17 transformation patterns has a negative impact on either of the selected process characteristics, i.e., process characteristic X and process characteristic Y, the transformation pattern is eliminated from the 17 identified transformation patterns.

FIG. 3a and FIG. 3b is a flowchart of a method for selecting transformation patterns for optimizing the process characteristics, in accordance with an embodiment of the invention.

The transformation patterns are selected from the transformation patterns identified at step 108, explained in conjunction with FIG. 1. The transformation patterns are selected to optimize the process characteristics identified at step 106, explained in conjunction with FIG. 1. Based on the applicability of the transformation patterns, one or more transformation patterns are selected.

At step 302, the first transformation pattern is selected from the identified transformation patterns. At step 304, it is determined whether any other data points are required to check the applicability of the selected transformation pattern. Data points refer to the information corresponding to the business process that is used to check the applicability of the transformation patterns. For example, information such as set-up time, processing time, and so forth, can be used as data points to check the applicability of the transformation patterns. The data points have been explained in conjunction with FIG. 1. In an embodiment of the invention, the data points are stored in the pattern repository. If few data points are required to check the applicability of the selected transformation patterns, the process moves to step 306. However, if, at step 304, it is determined that no other data points are required to check the applicability of the selected transformation pattern, the process moves to step 312.

At step 306, it is determined whether the data points required can be obtained or not. In an embodiment of the invention, the data points are obtained from the business user(s). In another embodiment of the invention, the data points are obtained from execution data information stored in a database. If the data points cannot be obtained, the process moves to step 308. However, if, at step 306, it is determined that the data points can be obtained, the process moves to step 310.

At step 308, it is determined whether the data points can be estimated or not. It will be apparent to a person skilled in the art that the data points can be estimated by a business user or a person executing the process. For example, at a retail store billing counter, the cashier can tell that he/she “handles about 30 customers in the 8 hour shift.” Therefore, the average time will be approximately 15 minutes per customer, and the data point used will be mean time. The cashier may further add that “some customers have only 1 or 2 items and take only a minute to handle. In contrast, some customers buy whole month's grocery and billing takes almost half an hour.” Therefore, high standard deviation is involved which can be used as a second data point. If the data points can be estimated, the process moves to step 310. However, if, at step 308, it is determined that the data points cannot be estimated, the process moves to step 312.

At step 310, the data points required to check or test the applicability of the transformation patterns are captured. The data points are captured either by obtaining the data points as explained in step 306 or by estimating the data points as explained in step 308. At step 312, one or more applicability algorithms, also referred to as optimization algorithms, are applied as explained in conjunction with FIG. 1. The applicability algorithms are applied to generate transformation possibilities for the business process. In other words, the applicability algorithms are applied to determine whether the transformation pattern, selected at step 302, can be applied in the business process or not. In an embodiment of the invention, the applicability algorithms utilize the data points to generate the transformation possibilities as explained in conjunction with FIG. 1. In an embodiment of the invention, the applicability algorithms are stored in the pattern repository. Further, the applicability algorithms also determine the point of applicability of the transformation patterns. The transformation patterns are applied at the point of applicability as explained in conjunction with FIG. 1. A transformation pattern is applied to an activity in a process, a group of activities in a process or to the process itself. The transformation pattern can also be applied to the resources that perform the activity, or to the location where the activity is performed.

At step 314, it is determined whether the selected transformation pattern satisfies one or more criteria or not. The one or more criteria refer to the one or more conditions mentioned in the applicability algorithms. For example, the applicability algorithm corresponding to the transformation pattern ‘Exception’, as explained in conjunction with FIG. 1, includes the following two criteria: ‘Standard Deviation=‘High’’ and ‘Number of cases where standard deviation is ‘High’>30%’. If the selected transformation pattern satisfies at least one of the one or more criteria, the process moves to step 316. Further, if, at step 314, it is determined that the transformation pattern does not meet the criteria, the process moves to step 318. At step 316, the selected transformation pattern is included in the list of the applicable transformation patterns. The list of the applicable transformation patterns includes one or more transformation patterns to be applied in the business process.

At step 318, it is determined whether any other transformation pattern needs to be selected or checked. All the identified transformation patterns are checked separately at step 318. If no other identified transformation pattern needs to be checked or, in other words, all transformation patterns selected at step 108 have been checked, the list of the applicable transformation patterns generated at step 316 is displayed. If all the identified transformation patterns have not been selected, then, at step 320, the next identified transformation pattern is selected. Thereafter, the process moves to step 304 to determine whether any other data points are required to check the applicability of the selected transformation pattern. Similarly, steps 306, 308, 310, 312, 314 and 316 are repeated for the selected transformation pattern until no other identified transformation pattern needs to be selected.

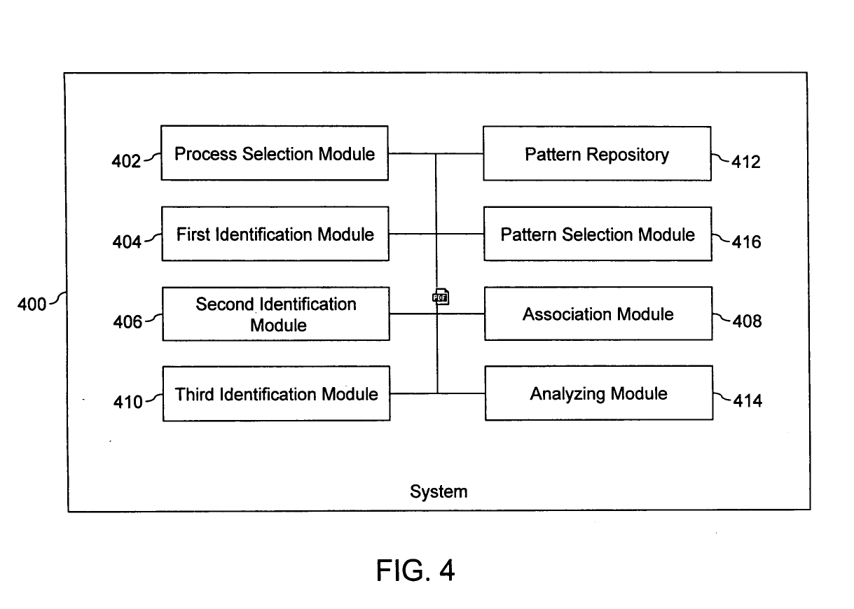

FIG. 4 is a block diagram of a system 400 for optimizing the business processes in the organization, in accordance with an embodiment of the invention. System 400 includes a process selection module 402, a first identification module 404, a second identification module 406, an association module 408, a third identification module 410, a pattern repository 412, an analyzing module 414, and a pattern selection module 416.

In various embodiments of the invention, system 400 enables a user to optimize one or more business processes in an organization. The business processes are optimized or redesigned to improve the functions of the organization and/or to resolve the issues or problems in the business process.

Process selection module 402 is configured to select a business process to be optimized. The business process is selected from the different business processes in the organization that need to be optimized or redesigned. For example, an organization such as a software services company employs different processes such as new project initiation process, billing of a project or project invoice generation, and so forth. In an exemplary scenario, when both the processes mentioned above need to be optimized, then each process is selected separately.

First identification module 404 is configured to identify at least one of performance indicators and improvement opportunities. The performance indicators and the improvement opportunities are associated with the business process; therefore, either of the two or both are identified corresponding to the business process. The performance indicators and the improvement opportunities have been explained in detail in conjunction with FIG. 1. In an embodiment of the invention, the performance indicators are identified by a business user on the basis of the business requirements of the organization. The performance indicators are identified by using a reference list containing predefined performance indicators. In another embodiment of the invention, the performance indicators for a process are defined by a business user on the basis of the business requirements of the organization. In an embodiment of the invention, one or more performance indicators generated or defined with the execution of one or more processes are collated to generate a reference list of the performance indicators. In an embodiment of the invention, system 400 is an evolving and self-learning system that stores, recalls and utilizes previously used information such as performance indicators. In yet another embodiment of the invention, the improvement opportunities are identified and/or defined by a user or a business user.

Second identification module 406 is configured to identify one or more process characteristics. The process characteristics have been explained in detail in conjunction with FIG. 1. The process characteristics are identified from a predefined set of process characteristics. The predefined set of process characteristics includes, but is not limited to, process characteristics such as cost, time, flexibility, reliability, throughput, effectiveness, quality, and control. Each process characteristic corresponds to one or more performance indicators of the business process and vice versa, as explained in conjunction with FIG. 1. Second identification module 406 is further configured to identify the impact of the process characteristics on the performance indicators as explained in conjunction with FIG. 1.

Association module 408 is configured to associate the improvement opportunities or issues with the process characteristics. For example, in the project invoice generation process in a software services company, the issue of the time taken to finalize the invoice for a project relates to the process characteristic ‘cycle time’. Similarly, the issue of miscommunication between the project managers and the finance department relates to the process characteristic ‘quality’. In an embodiment of the invention, association module 408 is configured to identify some of the process characteristics as constraints as explained in conjunction with FIG. 1. Association module 408 is further configured to define association between the performance indicators and the process characteristics as explained in conjunction with FIG. 1. In an embodiment of the invention, the association of the performance indicators and/or the improvement opportunities with the process characteristics is predefined and can be modified by a consultant or a practitioner. In an embodiment of the invention, the association of the performance indicators and/or the improvement opportunities with the process characteristics is defined by a user or a consultant. The associations defined or modified by the user during the execution of different processes are stored and used as predefined associations by the system for use in the future. In an embodiment of the invention, system 400 is an evolving and self-learning system that stores, recalls and utilizes previously used information such as association of process characteristics with the performance indicators and/or improvement opportunities.

Third identification module 410 is configured to identify at least one transformation pattern corresponding to the process characteristics. The transformation pattern is identified from a predefined set of transformation patterns. The predefined set of transformation patterns includes, but is not limited to, transformation patterns explained in conjunction with FIG. 1. In an embodiment of the invention, system 400 is an evolving and self-learning system that stores, recalls and utilizes previously used transformation patterns and also new transformation patterns (if any). Each transformation pattern in the predefined set of transformation patterns corresponds to at least one of the process characteristics and vice versa. The transformation patterns are identified on the basis of at least one predefined criterion. The predefined criterion includes, but is not limited to, a predefined relation between the transformation pattern and the process characteristic. In an embodiment of the invention, the predefined relation between the transformation pattern and the process characteristic includes the impact of the transformation pattern on the process characteristic. The predefined relation also includes the impact of the transformation pattern on the process characteristics identified as a constraint. The identification of the transformation patterns on the basis of the predefined criterion has been explained in detail in conjunction with FIG. 1 and FIG. 2.

Pattern repository 412 is configured for storing the predefined set of process characteristics and the predefined set of transformation patterns. The predefined set of transformation patterns is stored in a format as explained in conjunction with FIG. 1. Pattern repository 412 is further configured for storing the impact of the transformation pattern on the process characteristic as explained in detail in conjunction with FIG. 1.

Analyzing module 414 is configured to analyze a set of data points corresponding to the business process. The data points are used for checking the applicability of the transformation patterns identified by third identification module 410 as explained in detail in conjunction with FIG. 1, FIG. 3a and FIG. 3b. In an embodiment of the invention, the data points are stored in pattern repository 412.

Analyzing module 414 is further configured to check the applicability of the identified transformation patterns by using one or more applicability algorithms. In an embodiment of the invention, the applicability algorithms utilize the data points to check the applicability of the identified transformation patterns as explained in conjunction with FIG. 1. In an embodiment of the invention, the applicability algorithms are stored in pattern repository 412.

Pattern selection module 416 is configured to select one or more transformation patterns. The transformation patterns are selected from the transformation patterns identified by third identification module 410. The transformation patterns are selected on the basis of the applicability of the identified transformation patterns, as explained in detail in conjunction with FIG. 1, FIG. 3a and FIG. 3b. The transformation patterns are selected from the identified transformation patterns to optimize the process characteristics. The transformation patterns are also selected from the identified transformation patterns to satisfy the constraints. The optimization of the process characteristics, including the optimization of the process characteristics, identified as constraints, optimizes the business process.

Pattern selection module 416 is further configured to identify one or more points of applicability of the selected transformation patterns. Pattern selection module 416 is further configured to apply the selected transformation patterns. The selected transformation patterns are applied in the business process at the one or more points of applicability, as explained in conjunction with FIG. 1, FIG. 3a and FIG. 3b. In an embodiment of the invention, the result of the application of the selected transformation patterns is checked using simulations. The result is checked by comparing the outcomes of the optimized business process and the original business process in terms of the improvement opportunities and/or the performance indicators.

In an exemplary scenario, an organization, such as a software services company, employs different business processes such as new project initiation, project billing or invoice generation for a project. The business process such as project billing needs to be optimized and is therefore selected. Improvement opportunities or issues associated with the project billing process, such as the time taken to set up a project, miscommunication between project managers and the finance department, and the like, are then identified. Process characteristics such as cycle time, quality, and the like, are identified for the corresponding improvement opportunities. The issue of the time taken to set up a project relates to process characteristic ‘cycle time’, and the issue of miscommunications relates to process characteristic ‘quality’. Transformation patterns such as ‘Split Responsibilities’, and the like, are then identified from the pattern repository. These identified transformation pattern(s) have a positive impact on either of the two process characteristics. To test the applicability of the identified transformation patterns, data points are required for the mean time taken to complete the process and its standard deviation. The applicability of the identified transformation patterns is then checked by using the data points. A transformation pattern such as ‘Split Responsibilities’ is selected from the identified transformation patterns on the basis of the applicability of the identified transformation patterns. Based on the selected transformation pattern(s), the practitioner applies the transformation patterns at the point of applicability and thus optimizes or redesigns the business process. In an exemplary scenario, a new role of a Financial Analyst is created. The person is trained in financial matters and is also a part of the project team. As described in the example above, the applicability of the transformation pattern such as ‘Split Responsibilities’ helped in reducing the inter-department miscommunications and the related delays.

The method, system and computer program product described above have several advantages. The method provides a practitioner or a consultant with an efficient method for optimizing and redesigning business processes. Further, the business processes can be redesigned by using the available information since the method does not impose any rigid information requirement. Furthermore, the present invention provides a method for process redesign that is easy to understand and simple to implement. Moreover, the present invention brings structure into the art of process redesign.

The system for optimizing business processes in an organization, as described in the present invention or any of its components, may be embodied in the form of a computer system. Typical examples of a computer system include a general-purpose computer, a programmed microprocessor, a micro-controller, a peripheral integrated circuit element, and other devices or arrangements of devices that are capable of implementing the steps that constitute the method of the present invention.

The computer system comprises a computer, an input device, a display unit and the Internet. The computer further comprises a microprocessor, which is connected to a communication bus. The computer also includes a memory, which may include Random Access Memory (RAM) and Read only Memory (ROM). The computer system also comprises a storage device, which can be a hard disk drive or a removable storage drive such as a floppy disk drive, an optical disk drive, etc. The storage device can also be other similar means for loading computer programs or other instructions into the computer system. The computer system also includes a communication unit, which enables the computer to connect to other databases and the Internet through an Input/ Output (I/O) interface. The communication unit also enables the transfer as well as reception of data from other databases. The communication unit may include a modem, an Ethernet card, or any similar device which enable the computer system to connect to databases and networks such as Local Area Network (LAN), Metropolitan Area Network (MAN), Wide Area Network (WAN) and the Internet. The computer system facilitates inputs from a user through an input device, accessible to the system through an I/O interface.

The computer system executes a set of instructions that are stored in one or more storage elements, in order to process the input data. The storage elements may also hold data or other information as desired. The storage element may be in the form of an information source or a physical memory element present in the processing machine.

The present invention may also be embodied in a computer program product for optimizing business processes in an organization. The computer program product includes a computer usable medium having a set program instructions comprising a program code for optimizing business processes in an organization. The set of instructions may include various commands that instruct the processing machine to perform specific tasks such as the steps that constitute the method of the present invention. The set of instructions may be in the form of a software program. Further, the software may be in the form of a collection of separate programs, a program module with a large program or a portion of a program module, as in the present invention. The software may also include modular programming in the form of object-oriented programming. The processing of input data by the processing machine may be in response to user commands, results of previous processing or a request made by another processing machine.

While the preferred embodiments of the invention have been illustrated and described, it will be clear that the invention is not limit to these embodiments only. Numerous modifications, changes, variations, substitutions and equivalents will be apparent to those skilled in the art without departing from the spirit and scope of the invention, as described in the claims.

1. A method for optimizing one or more business processes in an organization, the method comprising:
a. selecting at least one business process to be optimized;
b. identifying at least one of one or more performance indicators and one or more improvement opportunities associated with the at least one business process;
c. identifying one or more process characteristics corresponding to each of the one or more performance indicators and the one or more improvement opportunities, wherein, the one or more process characteristics being identified from a predefined set of process characteristics;
d. identifying at least one transformation pattern corresponding to each of the one or more process characteristics, wherein, the at least one transformation pattern being identified from a predefined set of transformation patterns, the identification being done based on at least one predefined criterion; and
e. selecting one or more transformation patterns for optimizing the one or more process characteristics, the one or more transformation patterns being selected from the identified transformation patterns based on applicability of the identified transformation patterns in the business process.

2. The method of claim 1, further comprising identifying a point of applicability of the selected transformation patterns in the one or more business processes, wherein the selected transformation patterns are applied in the business process at a point of applicability.

3. The method of claim 2, further comprising applying the selected transformation patterns at the point of applicability.

4. The method of claim 1, wherein identifying the at least one of the one or more performance indicators and the one or more improvement opportunities comprises defining the one or more performance indicators of the business process, wherein the one or more performance indicators are defined by an user.

5. The method of claim 1, further comprising associating at least one of an improvement opportunity and a performance indicator with at least one process characteristic.

6. The method of claim 1, wherein the predefined set of process characteristics comprises at least one of cost or time or flexibility or reliability or quality or throughput or control or effectiveness or any combinations thereof.

7. The method of claim 1, wherein the predefined set of process characteristics and the set of predefined transformation patterns are stored in a pattern repository.

8. The method of claim 7, wherein the at least one predefined criterion is based on impact of the at least one transformation pattern on the corresponding process characteristics wherein the at least one predefined criterion is and stored in the pattern repository.

9. The method of claim 1, further comprising analyzing a set of data points corresponding to the business process, wherein the set of data points is used for checking the applicability of the identified transformation patterns.

10. The method of claim 9, wherein the applicability of the identified transformation patterns is checked using one or more applicability algorithms.

11. A system for optimizing business processes in an organization, the system comprising:
a. a process selection module configured for selecting one or more business processes to be optimized;
b. a first identification module configured for identifying at least one of one or more performance indicators and one or more improvement opportunities associated with the business process;
c. a second identification module configured for identifying one or more process characteristics corresponding to each of the one or more performance indicators and the one or more improvement opportunities, the one or more process characteristics being identified from a predefined set of process characteristics;
d. a third identification module configured for identifying at least one transformation pattern corresponding to each of the one or more process characteristics, the at least one transformation pattern being identified from a predefined set of transformation patterns, the identification being done based on at least one predefined criterion; and
e. a pattern selection module configured for selecting one or more transformation patterns for optimizing the one or more process characteristics, the one or more transformation patterns being selected from the identified transformation patterns based on applicability of the identified transformation patterns in the business process.

12. The system of claim 11, wherein the first identification module is further configured for defining the one or more performance indicators of the business processes, wherein the one or more performance indicators are defined by an user.

13. The system of claim 11 further comprising an association module configured for associating at least one of an improvement opportunity and a performance indicator with at least one process characteristic.

14. The system of claim 11, wherein the predefined set of process characteristics comprises at least one of cost or time or flexibility or reliability or quality or throughput or control or effectiveness or any combinations thereof.

15. The system of claim 11, wherein the at least one predefined criterion is based on impact of the at least one transformation pattern on the corresponding process characteristics, wherein the at least one predefined criterion is stored in a pattern repository.

16. The system of claim 15, further comprising an analyzing module configured for analyzing a set of data points corresponding to the business process, wherein the set of data points is used for checking the applicability of the identified transformation patterns and is stored in the pattern repository.

17. The system of claim 15, wherein the pattern repository is further configured for storing one or more of the predefined set of process characteristics, the predefined set of transformation patterns, and impact of the transformation pattern on a process characteristic.

18. The system of claim 17, wherein the applicability of the identified transformation patterns is checked using one or more applicability algorithms.

19. The system of claim 11, wherein the pattern selection module is further configured for identifying a point of applicability of the selected transformation patterns in the business process, wherein the selected transformation patterns are applied in the business process at the point of applicability.

20. The system of claim 19, wherein the pattern selection module is further configured for applying the selected transformation patterns at the point of applicability.

21. A computer program product for use with a computer, the computer program product comprising a computer usable medium having a computer readable program code embodied therein for optimizing business processes in an organization, the computer readable program code performing:
a. identifying one or more performance indicators of a business process
b. identifying one or more process characteristics corresponding to each of the one or more performance indicators, the one or more process characteristics being identified from a predefined set of process characteristics;
c. identifying at least one transformation pattern corresponding to each of the one or more process characteristics, the at least one transformation pattern being identified from a predefined set of transformation patterns, the identification being done based on at least one predefined criterion; and
d. selecting one or more transformation patterns for optimizing the one or more process characteristics, the one or more transformation patterns being selected from the identified transformation patterns based on applicability of the identified transformation patterns in the business process.

22. The computer program product of claim 21, wherein the computer program code further performs analyzing a set of data points corresponding to the business process, wherein the set of data points is used for checking the applicability of the identified transformation patterns.

23. The computer program product of claim 21, wherein the computer program code further performs identifying a point of applicability of the selected transformation patterns in the business process, wherein the selected transformation patterns are applied in the business process at the point of applicability.

24. The computer program product of claim 23, wherein the computer program code further performs applying the selected transformation patterns at the point of applicability.
